(19) United States
(12) Patent Application Publication
(10) Pub. No.: US 2016/0094158 A1
(43) Pub. Date: Mar. 31, 2016

(54) METHOD FOR POWER STATION SIMULATION

(71) Applicant: Siemens Aktiengesellschaft, Munich (DE)

(72) Inventors: Dieter Kleyer, Herzogenaurach (DE); Torsten Olthoff, Uttenreuth (DE)

(73) Assignee: Siemens Aktiengesellschaft, Munich (DE)

(21) Appl. No.: 14/861,119

(22) Filed: Sep. 22, 2015

(30) Foreign Application Priority Data
Sep. 29, 2014 (DE) 102014219711.2

(51) Int. Cl. H02N 11/00; G05B 19/05

(52) U.S. Cl. CPC H02N 11/002; G05B 19/05; G05B 2219/13186

(57) ABSTRACT

A method for power station simulation by means of a piece of distributed simulation hardware allows automatic and unaltered adoption of an automation solution intended for a respective original system and in the process specifically also converts communication relationships between devices of the original system into communication relationships between corresponding emulation components.

### CROSS REFERENCE TO RELATED APPLICATIONS

This application claims the benefit of German Application No. DE 102014219711.2 filed 29 Sep. 2014, incorporated by reference herein in its entirety.

### FIELD OF INVENTION

The invention relates to a method for simulating a power station process and an automation solution provided for the automation thereof (power station simulation).

### BACKGROUND OF INVENTION

Methods for power station simulation are known per se in principle but exist essentially as proprietary solutions and are therefore elaborate to produce, maintain and/or update. Since a power station simulation is also unique as a rule, corresponding costs result.

To produce a power station simulation economically, it would be desirable to be able to use an automation solution that is provided for the respective original system, that is to say the real or the projected automation hardware intended for automating the respective power station process.

The respective automation solution comprises project planning that maps the original system, and which stipulates the type and number of devices in the automation hardware, for example. In this case, the automation hardware comprises at least also what are known as programmable logic controllers (PLC) and the peripheral hardware, which can comprise simple “I/O” assemblies without preprocessing functionality but also complex assemblies with preprocessing functionality. Accordingly, the automation solution also includes at least one PLC program and respective parameterization and configuration of the peripheral hardware. The sum total of the PLC programs is referred to in summary as automation software, and the PLC programs are computer programs for a specific piece of hardware, that is to say computer programs based on the IEC 61131/EN 61131 standard, for example.

A power station simulation is conventionally divided into a process-engineering simulation of the power station process and an emulation of the control-engineering installation/automation hardware, that is to say of the devices and units of the original system. In principle, what is known as a soft PLC can be considered for emulating a PLC of the original system, said soft PLC being known to allow, in the form of a computer program that is executable on a conventional computer, the execution of PLC programs independently of a really existent PLC on the respective computer. The same applies accordingly for emulation of the peripheral assemblies.

### SUMMARY OF INVENTION

Against the background of this prior art, an object of the present invention is primarily to make the functionality of a programmable logic controller or the functionality of a programmable logic controller together with the functionality of the peripheral assemblies available for a power station simulation too and at the same time to be able to continue to use the respective automation solution without alteration.

The invention achieves this object with a method for power station simulation having the features of the independent claim. To this end, a method for power station simulation by means of a piece of simulation hardware, particularly a piece of distributed simulation hardware, that comprises at least one emulation unit, having at least one emulation component running on the or each emulation unit, and at least one simulation unit having a process model, wherein one and the same device in the simulation hardware can also simultaneously act as an emulation unit and as a simulation unit, has provision for the following: an automation solution intended for the power station that is to be simulated or the power station process that is to be simulated is used in unaltered form for the power station simulation by virtue of each emulation component being assigned a PLC program that the automation solution comprises and the emulation component acting as a soft PLC, wherein, in one particular embodiment of the method, the peripheral and communication assemblies of the original system are furthermore also recreated in the emulation. Project planning that the automation solution comprises is automatically evaluated in order to obtain communication relationship data, wherein the communication relationship data describe communication relationships between the emulation components, specifically on the basis of the communication relationships that exist or are provided between the emulated devices of the automation hardware in accordance with the project planning. During the simulation, each emulation component executes the PLC program respectively assigned to it and for that purpose accesses firstly PLC functions and secondly system functions. The PLC functions allow at least execution of program commands of the PLC program for combining operands and the like. The system functions allow at least execution of program commands of the PLC program for communication with another emulation component. At least individual system functions therefore recreate those functions that, for a real PLC of the original system, allow communication with another PLC that is likewise part of the original system. In this case, the special feature of the communication for the simulation is that the communication takes place not between real devices but rather between the emulation components, that is to say computer programs, that represent the devices of the original system. When two emulation components are intended to interchange data with one another in accordance with the project planning, the two emulation components may be instantiated on the same emulation unit or on different emulation units. When the two emulation components are instantiated on the same emulation unit, the communication can proceed as internal communication within the respective emulation unit. When the two emulation components are instantiated on different emulation units, there is a need not only for the data interchange between the emulation components but also for data interchange between the respective emulation units. This is subsequently referred to as external communication for short and to distinguish it from internal communication. The method proposed here for power station simulation by means of a piece of, in particular, distributed, simulation hardware accordingly has provision for execution of a system function for communication with another emulation component to involve resorting to the communication relationship data, so that either internal communication or external communication automatically takes place on the basis thereof.

The advantage of the invention is that the targeted unaltered adoption of the automation solution (originally) provided for the original system becomes possible. In this case, the functionality of the individual emulation components as a soft PLC is embodied such that an interpreter is used to convert the PLC commands/program commands of each PLC program into operations that can be executed by means of the microprocessor of the emulation unit, on which microprocessor the emulation component is intended to be executed. In this case, by way of example, the interpreter provides a function that recreates the hardware registers, what are known as the accumulators, of a real PLC in software. The times and counters implemented for a real PLC in the form of registers are also recreated by the interpreter in software. For what are known as flags, a real PLC provides specific memory areas that allow fast access. The interpreter recreates this functionality in software for the memory structure of the respective standard computer used as an emulation unit. For what are known as organization modules, the operating system on a real PLC provides execution levels that are recreated within the emulation in the form of process calls. Finally, the emulation also recreates the mechanism for accessing individual data, as takes place for a real PLC by means of addressing the data within data modules. This list does not claim to be complete. In summary, it is at any rate possible to establish that the emulation component/soft PLC can execute the original code of the respective PLC program in unaltered form and comprises means that are necessary for that purpose, namely firstly the aforementioned interpreter, which processes the individual program commands of the PLC program and converts them into a form that can be executed on the respective emulation unit, and secondly the PLC functions and system functions that are accessed when the PLC program is executed.

Within the emulation, the execution properties of a real PLC are matched to the execution properties of standard computers. A basic cycle that runs continuously in the original system is called cyclically in the emulation, that is to say every 100 ms, for example. Time-controlled execution levels, that is to say, by way of example, execution levels with a cycle time of 30 ms, 100 ms, 200 ms, etc., are likewise called in a fixed cycle, for example likewise every 100 ms, in the emulation. Alarm-controlled execution levels that are activated by means of errors and faults in the original system are likewise handled in a fixed cycle in the emulation.

One special feature of the emulation is the need for handling an internal and external communication between two respective emulation components and if need be two emulation components and the respective emulation units. In the original system, the automation devices represented by the emulation components are each of separate design and connected to one another by means of buses or the like. Communication between such devices takes place on the basis of protocols that are known per se. In this case, data blocks are interchanged between the individual automation devices, and the communication functions that are necessary for that purpose are typically provided by the operating system of the respective PLC.

Within the emulation, the recreated automation devices may be arranged on one or more emulation units (standard computers), so that internal or external communication becomes necessary. Internal communication is realized for the emulation by data interchange using global data from the respective emulation unit. External communication is realized within the emulation by means of communication between the respective emulation units involved and use of communication protocols that are known per se. In both cases, the content of the data blocks transmitted between the emulation components remains unaltered, so that the original automation solution can continue to be used without alteration.

Advantageous embodiments of the invention are the subject matter of the subclaims. Back-references used therein indicate the further development of the subject matter of the main claim by the features of the respective subclaim. They are not intended to be understood as dispensing with the attainment of independent, substantive protection for the combinations of features of the dependent subclaims. Furthermore, in respect of interpretation of the claims for more detailed specification of a feature in a subordinate claim, it can be assumed that such limitation is not present in the respective preceding claims.

In one specific embodiment of the method for power station simulation, the automatic evaluation of the project planning of the automation solution of the power station to be simulated/the power station process to be simulated involves the automatic generation of communication relationship data, wherein calling a system function for communication with another emulation component on the basis of the communication relationship data involves internal communication being set up and taking place between two emulation components running on the same emulation unit within the respective emulation unit or external communication being set up and taking place between two emulation components running on different emulation units and the respective emulation units.

In a further or alternative embodiment of the method for power station simulation, the assignment of a respective PLC program to a respective emulation component on the basis of automatic evaluation of the project planning of the automation solution of the power station to be simulated takes place by virtue of emulation components that act as a soft PLC being automatically instantiated on individual emulation units in accordance with the project planning and each emulation component being assigned a respective PLC program. This can be effected by means of what are known as load distribution algorithms, which are fundamentally known per se, with at least a computation power and/or a memory capacity of the respective emulation units being taken into account. In one particular embodiment, optimized distribution over the emulation components takes place on the premise that the number of external communication relationships is minimal.

The aforementioned object is also achieved with a, in particular distributed, simulation system for power station simulation that operates on the basis of the method as described here and below and to this end comprises means for performing the method.

The aforementioned object is likewise achieved with a method for automatic adoption of an automation solution of an original system for a simulation system provided for power station simulation. In this case, a computer program, referred to here and below as a loading program, is used to automatically assign PLC programs that the automation solution comprises to individual emulation components instantiated on an emulation unit of the simulation system, and the loading program is used to automatically evaluate project planning that the automation solution comprises in order to generate communication relationship data. The communication relationship data are data that are generated on the basis of the project planning of the original system and on the basis of which an automatic decision is possible concerning whether communication by one emulation component with another emulation component can be handled in the form of internal communication between two emulation components running on the same emulation unit within the respective emulation unit or in the form of external communication between two emulation components running on different emulation units and the respective emulation units.

As far as the simulation system operating on the basis of the method described here and below and also the loading program and the method for automatic adoption of the automation solution of a respective original system are concerned, the invention is implemented in software. The invention is therefore firstly also a computer program having program-code instructions that can be executed by a computer and secondly a storage medium having a computer program of this kind, that is to say a computer program product having program code means, and also finally firstly also a computer or the like that is combined with other identical or similar devices in a network and into whose memory such a computer program has been loaded or can be loaded as means for performing the method and the embodiments thereof, and secondly the computer network as a whole that acts as a simulation system.

An exemplary embodiment of the invention is explained in more detail below with reference to the drawing. Items or elements that correspond to one another are provided with the same reference symbols in all the figures.

The exemplary embodiment is not intended to be understood as a restriction of the invention. Rather, the present disclosure by all means also allows additions and modifications, particularly such additions and modifications as, for example through combination or modification of individual features or method steps that are described in conjunction with the general or specific part of the description and are contained in the claims and/or the drawing, are evident to a person skilled in the art for achieving the object and, through combinable features, result in a new item or in new method steps or series of method steps.

### BRIEF DESCRIPTION OF THE DRAWINGS

In the figures,

FIG. 1 shows a simulation system with a piece of distributed simulation hardware, and

FIG. 2 shows a simulation unit as part of the simulation system.

### DETAILED DESCRIPTION OF INVENTION

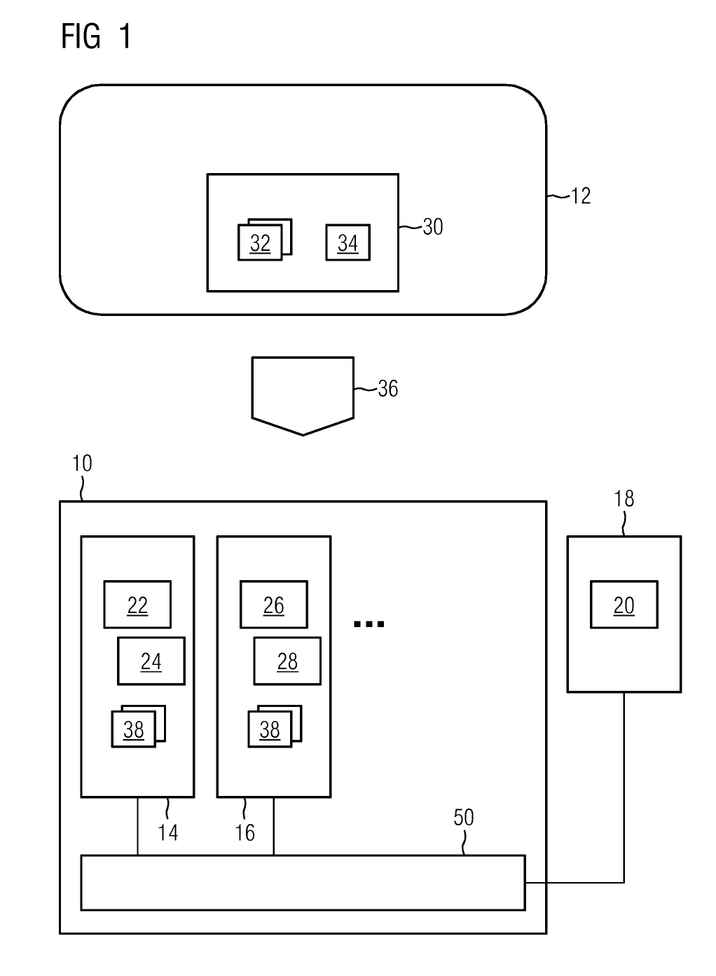

The illustration in FIG. 1 shows a schematically highly simplified form of a simulation system 10 as an apparatus for power station simulation, namely for simulation of a power station or power station process. The simulated power station/the simulated power station process is/are not shown separately in the illustration. It is also possible to dispense therewith because power stations and power station processes are known per se, for example in the form of a power station for generating hydroelectric power. In principle, the simulation system 10 allows simulation of any power station processes. For the purpose of automating the respective power station/power station process, a piece of automation hardware that is subsequently referred to as original system 12 for short is provided. The original system 12 includes at least one programmable logic controller (not shown). Often, it can be assumed that the original system 12 includes a multiplicity of programmable logic controllers. Frequently, the original system 12 furthermore also includes peripheral and/or communication assemblies (likewise not shown).

The approach presented here involves a piece of simulation hardware, particularly a piece of distributed simulation hardware, being used for the power station simulation. The distributed simulation hardware comprises different devices, which may each be standard computers, that are referred to as emulation unit 14, 16 or simulation unit 18 for distinction according to function. In individual cases, one and the same device in the simulation hardware can also simultaneously act as an emulation unit 14, 16 and simulation unit 18, so that the simulation hardware is limited to a single device.

A process model 20 is instantiated on the simulation unit 18 or on a plurality of simulation units 18 as computer program, if need be as a distributed computer program, for simulating the respective power station process. Instantiated on the or each emulation unit 14, 16 is a respective emulation component 22-28 running on the respective emulation unit 14, 16. Each emulation component 22-28 represents a device or unit of the original system 12, that is to say a PLC of the real or projected automation hardware, for example.

The approach presented here is primarily intended to allow an automation solution 30 intended for the power station to be simulated to be accepted in unaltered form for the simulation. The automation solution 30 is shown in the schematically simplified illustration in FIG. 1 as an element of the original system 12, since conventionally an automation solution 30 is produced for a piece of real or projected automation hardware in order to control, regulate and/or monitor a respective technical process—in this case a power station process. In this case, the automation solution 30 comprises at least one PLC program 32, usually a multiplicity of PLC programs 32, and project planning 34 that describes the automation hardware and networking (communicative connection) of individual devices of the automation hardware to one another.

For the purpose of simulating the respective power station/power station process, each emulation component 22-28 is assigned, in unaltered form, precisely one PLC program 32 that the automation solution 30 comprises. This is accomplished using a software functionality that is subsequently referred to as loading program 36. The loading program 36 is also used to automatically evaluate the project planning 34 of the automation solution 30 in order to obtain communication relationship data 38. These describe communication relationships between the emulation components 22-28 and the respective resultant communication relationships between the emulation components 22-28 correspond to the communication relationships that exist in the original system 12 between the relevant programmable logic controllers therein or that would exist in an implementation of the original system 12.

The emulation components 22-28 of the simulation system 10 that are provided for emulating a programmable logic controller of the original system 12 act as a soft PLC and are accordingly intended and set up to execute PLC programs 32. The functionality of a soft PLC is known per se. However, known soft PLCs do not need to communicate with another soft PLC, which means that communication functions are not implemented. For the purpose of execution on a conventional soft PLC, it has thus at best been possible to date, to a certain extent, to adopt a simple PLC program 32 that does not contain any communication functions. For the approach presented here, it is assumed that normally—owing to the complexity of the power station process and/or the physical extent—a multiplicity of PLCs are required within the original system 12 for implementing the automation solution 30 and hence communication between the PLCs is necessary. This results in a need for communication between the emulation components 22-28 of the simulation system 10 too. Use of a soft PLC of the type known to date is thus out of the question for implementing the functionality of an emulation component 22-28. Furthermore, the approach presented here is also not limited to extending the functionality of a known soft PLC by communication functions, since automatic and unaltered adoption of the automation solution 30 also includes automatic adoption of the communication relationships provided in accordance with the project planning 34 and/or automatic adoption of the parameterization/configuration of the peripheral/communication assemblies that is provided in accordance with the project planning 34.

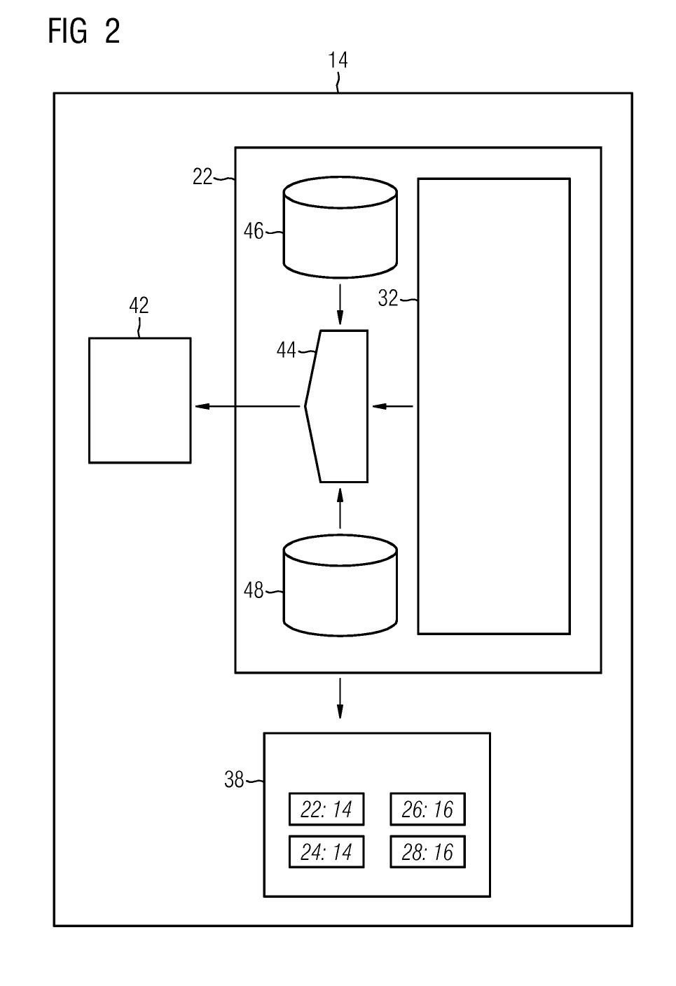

To this end, the illustration in FIG. 2 first of all shows—in a likewise schematically highly simplified form—an emulation unit 14 and an emulation component 22 instantiated thereon. The explanations below naturally relate to any emulation unit 14, 16 that the respective simulation system 10 comprises and to any emulation component 22-28 that is instantiated thereon.

By way of example, the emulation unit 14 is a standard computer and the emulation component 22 is accordingly loaded into the memory thereof as a computer program and is executed by the processor 42 thereof in a manner that is known per se. The emulation component 22 represents a PLC of the original system 12 and can accordingly be regarded as an independent process within a computer with a memory of its own. The PLC program 32 assigned to the emulation component 22 is loaded into the memory and comprises individual PLC program commands in a manner that is known per se. In this case, the PLC program 32 is adopted from the automation solution 30 intended for the original system 12 in unaltered form by means of the loading program 36. The processor 42 of the emulation unit 14, as a standard processor, is not provided for direct execution of PLC program commands, unlike a processor or the like that is used in a PLC. The PLC program commands are accordingly executed by means of an interpreter (PLC interpreter) 44 that converts the PLC program commands into instructions that the processor 42 of the emulation unit 14 can process and execute. To this end, the interpreter 44 at least also accesses a library with PLC functions 46 and a library with system functions 48. On the basis of the PLC functions 46, it becomes apparent how a PLC program command can be converted into program code instructions that can be executed by the processor 42. On the basis of the system functions 48, it becomes apparent how, by way of example, a special PLC program command that initiates a communication process between a first PLC and a second PLC in the original system 12 can be converted.

The system functions 48 correspond in the broadest sense to an implementation of the “operating system functions” of a real PLC. The system functions 48 can also be used to execute Java instructions, for example, or instructions in another “high-level language” as part of the respective PLC program 32. Special system functions 48 are used to enable any emulation component 22-28 to execute communication commands that the PLC program 32 contains.

A further aspect, based thereon, of the approach presented here relates to the respective communication links that are to be set up. Returning to the illustration in FIG. 1, it can be seen that various scenarios need to be handled, depending on whether the emulation components 22-28 between which data need to be interchanged are executed on one and the same emulation unit 12, 14 (internal communication) or on different emulation units 12, 14 (external communication).

Automatic setup of the respective communication links to be set up involves the communication relationship data 38 being evaluated. These comprise at least a piece of information concerning the emulation unit 14, 16 on which a respectively addressed emulation component 22-28 is instantiated. In the illustration in FIG. 2, this is shown purely schematically using the reference numerals that have been used to date. The text “22:14” therein is accordingly intended to clarify the information compiled in the communication relationship data 38, according to which the emulation component denoted in this case by the reference numeral 22 is instantiated on the emulation unit denoted in this case by the reference numeral 14. A similar situation applies to all other texts shown in the illustration in FIG. 2. Accordingly, the text “28:16” is intended to clarify the information compiled in the communication relationship data 38, according to which the emulation component denoted by the reference numeral 28 is instantiated on the emulation unit denoted by the reference numeral 16.

When, during the execution of a PLC program 32 within the simulation system 10, the interpreter 44 encounters a communication program command of the PLC program 32, firstly at least one system function 48 is called and secondly the communication relationship data 38 are requested. On the basis of the respective communication subscriber addressed in the communication program command and of the communication relationship data 38, it becomes apparent whether internal or external communication is necessary. On the basis of this, at least one system function 48 is called that allows either data interchange by internal communication using global data for the respective emulation unit 14, 16 or data interchange by external communication using the communication links that exist between the emulation units 14, 16—shown in the illustration in FIG. 1 using a bus connection 50 by way of example—and using the protocols respectively defined therefor.

In a particular embodiment of the method for power station simulation and of a corresponding simulation system 10, functions for recreating further hardware assemblies or hardware functions are provided as part of the emulation, that is to say within the scope of functionality of the emulation components 22-28. Said hardware assemblies and hardware functions are configured automatically on the basis of the respective installation engineering, that is to say on the basis of the automation solution 30 of the original system 12.

Examples of such assemblies that can be cited are particularly what are known as I/O assemblies. Such assemblies are recreated as part of the emulation in the form that the input and output signals interchanged with the process model 20 are transmitted to the process maps of the automation devices. The reconstruction of errors (malfunction), such as assembly failure or wire breakage, is likewise possible. The emulation likewise provides components for configuring such assemblies.

For the emulation of such assemblies, a distinction needs to be drawn between emulation of assemblies without what is known as preprocessing and emulation of assemblies with preprocessing.

In the case of emulation of an input assembly without preprocessing, the emulated assembly receives a digital equivalent in a similar fashion to real assemblies that are supplied via electrical signals. The input assembly then converts said digital equivalent into a process map of the inputs. In the case of an emulation of an output assembly without preprocessing, the emulated assembly outputs a digital equivalent in a similar fashion to real assemblies that output electrical signals. The output assembly produces said digital equivalent on the basis of the process maps of the outputs. The addressing of the assembly and hence of the process maps is contained in the project planning data from the original system 12 and is used for the hardware configuration. The emulation uses precisely this configuration to address the process maps.

In the real system, the process maps are transmitted cyclically at the assembly level, i.e. via slot (single assembly), rack (header assembly) and bus system. This involves the use of proprietary systems or Profibus. The emulation adapts this mechanism, so that the data interchange can take place within the simulation hardware, in particular on a computer-internal basis. The transmission takes place in a fixed cycle of 100 ms, for example. Exclusively the useful data (process maps) are transmitted. This takes place in a defined data area, that is to say what is known as the process map of the inputs, the process map of the outputs and/or by means of what are known as data modules, for example. A protocol that is used for the data transmission in the case of the real hardware, for example what is known as the Profibus protocol, is not recreated as part of the emulation but rather is replaced by a separate mechanism.

Depending on respective parameterization, certain assemblies can sense events, e.g. a signal change, and in this regard send reports to the control system of the automation hardware. The emulation recreates this functionality.

Within the respective original system 12, configuration data and parameterizations are produced from the project planning data of the power station installation using a generation process in the form of data modules and are then loaded onto individual assemblies. The form of the transfer of these data to a single assembly is dependent on the respective automation system. For the emulation, software pendants replace the real devices of the automation hardware, that is to say PLCs and peripheral/communication assemblies. Configurations and parameterizations are accordingly transmitted to the assembly emulation within the simulation hardware, in particular on a computer-internal basis. The emulation provides a component in this regard. The configuration data are produced (depending on the system) from the installation project planning of the original system 12, loaded into an emulation component 22-28 acting as a software pendant for an automation system (AS) and, from there, transmitted to the assembly emulation. Changes are loaded in the same manner, this being possible as an option as part of the emulation too, but in this case changes are already identified during the project planning and only these are loaded.

What are known as assemblies with preprocessing (“complex assemblies”) are normally implemented using specific hardware (microcomputer, FPGA, etc.) owing to a special task. Emulation of such assemblies is accordingly not possible in similar fashion to emulation of a programmable logic controller or a “simple” assembly. In a particular form of the simulation, the respective functional component of such assemblies is for this reason recreated using standard computer languages, such as C, C++, etc., so that execution on a standard computer is possible. Parameterizations can be used to vary the functionality of such assemblies in wide ranges. Within the emulation, these emulated assemblies are also handled in a fixed cycle of 100 ms, for example. Unlike in the original system 12, where such assemblies operate completely without restriction, the call in the emulation is made at the start (input assemblies) or at the end (output assemblies) of a cycle in each case.

Further assemblies recreated as an option as part of the emulation are what are known as FUM modules for drive controllers, for signal conditioning or for closed-loop controllers, that is to say specific hardware assemblies having a piece of software tuned specifically to a respective assembly function. The configuration and parameterization of such assemblies is also performed automatically on the basis of the unaltered installation engineering of the original system 12. The simulation system 10 comprises appropriate components for this too.

Yet further assemblies recreated as an option as part of the emulation are what are known as failsafe systems (F systems), exciter systems and special field devices. Failsafe systems are used in an original system 12 for combustor controls, for example. The emulation recreates these systems. The simulation system 10 provides a component that produces the configuration for such systems automatically from the unaltered installation engineering of the original system 12. Operation and observation and also actuation of what are known as exciter systems are effected within the control engineering. An exciter system is recreated in the process model 20. An exciter system is connected in the original system 12 via specific protocols that require specific hardware. Configuration of these protocols (interface) takes place within the simulation system 10 automatically from the unaltered installation engineering of the original system 12. For this too, the simulation system 10 has components having appropriate functionality. Field devices allow local handling of automation tasks. Optionally, such assemblies, particularly Profibus field devices, are also recreated within the simulation system 10. They are also configured within the simulation system 10 automatically from the unaltered installation engineering of the original system 12, and for this purpose the simulation system 10 has components having appropriate functionality.

In yet a further optional embodiment of the simulation system 10, said system also provides test functions, that is to say functions for loading a program code for testing or for dynamically displaying state values into the recreated automation systems.

Although the invention has been illustrated and described in more detail by means of the exemplary embodiment, the invention is not restricted by the disclosed example(s) and other variations can be derived therefrom by a person skilled in the art without departing from the scope of protection of the invention.

Individual foreground aspects of the description submitted here can therefore be briefly summarized as follows: The specification relates to a method for power station simulation by means of a piece of, in particular distributed, simulation hardware that allows automatic and unaltered adoption of an automation solution 30 intended for a respective original system 12 and in so doing specifically also converts communication relationships between devices of the original system 12 into communication relationships between corresponding emulation components 22-28, that is to say a method for power station simulation with automatic adoption of the installation engineering for the purpose of emulating PLC-based power station control engineering. In this case, the simulation system 10 comprises at least one emulation unit 14, 16, having at least one emulation component 22-28 running on the or each emulation unit 14, 16, and also at least one simulation unit 18 having a process model 20. The automation solution 30 intended for the power station that is to be simulated is used in unaltered form by virtue of each emulation component 22-28 being assigned a PLC program 32 that the automation solution 30 comprises, and the emulation component 22-28 acting as a soft PLC, and by virtue of project planning 34 that the automation solution 30 comprises being automatically evaluated in order to obtain communication relationship data 38, wherein the communication relationship data 38 describe communication relationships between the emulation components 22-28. While the simulation is running, each emulation component 22-28 executes its assigned PLC program 32 and for that purpose accesses PLC functions 46 and system functions 48. The PLC functions 46 allow at least execution of program commands of the PLC program 32 for combining operands and the system functions 48 allow at least execution of program commands of the PLC program 32 for communication with another emulation component 22-28. Execution of a system function 48 for communication with another emulation component 22-28 involves resorting to the communication relationship data 38, so that the communication relationships existing in the original system 12 are also recreated automatically and without additional action and are able to be used automatically and without additional action.

### LIST OF REFERENCE SYMBOLS

10 Simulation system
12 Original system
14 Emulation unit
16 Emulation unit
18 Simulation unit
20 Process model
22 Emulation component
24 Emulation component
26 Emulation component
28 Emulation component
30 Automation solution
32 PLC program
34 Project planning
36 Loading program
38 Communication relationship data
40 (unassigned)
42 Microprocessor
44 Interpreter
46 PLC functions
48 System functions
50 Bus connection

1. A method for power station simulation by means of a piece of simulation hardware that comprises at least one emulation unit, having at least one emulation component running on the or each emulation unit, and at least one simulation unit having a process model, the method comprising:
using an automation solution intended for the power station that is to be simulated in unaltered form by virtue of each emulation component being assigned a PLC program that the automation solution comprises and the emulation component acting as a soft PLC,
automatically evaluating project planning that the automation solution comprises in order to obtain communication relationship data and wherein the communication relationship data describe communication relationships between the emulation components,
executing by each emulation component the PLC program assigned to it and for that purpose accesses PLC functions and system functions, wherein the PLC functions allow at least execution of program commands of the PLC program for combining operands and the system functions allow at least execution of program commands of the PLC program for communication with another emulation component, and
executing of a system function for communication with another emulation component based on the communication relationship data.

2. The method as claimed in claim 1,
wherein the automatic evaluation of the project planning of the automation solution of the power station to be simulated comprises the automatic generation of communication relationship data and
wherein the execution of a system function for communication with another emulation component on the basis of the communication relationship data comprises internal communication taking place between two emulation components running on the same emulation unit within the respective emulation unit or external communication taking place between two emulation components running on different emulation units and the respective emulation units.

3. The method as claimed in claim 1,
wherein the assignment of a respective PLC program to a respective emulation component on the basis of automatic evaluation of the project planning of the automation solution of the power station to be simulated takes place by virtue of emulation components that act as a soft PLC being automatically instantiated on individual emulation units in accordance with the project planning and each emulation component being assigned a respective PLC program.

4. A method for automatic adoption of an automation solution of an original system for a simulation system provided for power station simulation, the method comprising:
using a loading program to automatically assign PLC programs that the automation solution comprises to individual emulation components instantiated on an emulation unit of the simulation system,
wherein the loading program is used to automatically evaluate project planning that the automation solution comprises in order to generate communication relationship data, and
automatically determining, on the basis of the communication relationship data whether communication by one emulation component with another emulation component can be handled in the form of internal communication between two emulation components running on the same emulation unit within the respective emulation unit or in the form of external communication between two emulation components running on different emulation units and the respective emulation units.

5. A computer program residing on a non-transitory computer readable media comprising
program code means adapted to perform the method of claim 1 when the computer program is executed in order to simulate a power station process.

6. A non-transitory digital storage medium comprising
electronically readable control signals that are adapted to interact with a computer intended for simulating a power station process such that the method as claimed in claim 1 is carried out.
